(19) United States
(12) Patent Application Publication
(10) Pub. No.: US 2009/0021503 A1
(43) Pub. Date: Jan. 22, 2009

(54) METHOD OF DRIVING PLASMA DISPLAY PANEL

(75) Inventor: Yoshito Tanaka, Chuo-shi (JP)

Correspondence Address: DRINKER BIDDLE & REATH (DC), 1500 K STREET, N.W., SUITE 1100, WASHINGTON, DC, 20005-1209, US

(73) Assignee: Pioneer Corporation, Meguro-ku (JP)

(21) Appl. No.: 12/166,134

(22) Filed: Jul. 1, 2008

(30) Foreign Application Priority Data
Jul. 19, 2007 (JP) 2007-188525

(51) Int. Cl. G06F 3/038

(52) U.S. Cl. 345/205

(57) ABSTRACT

This plasma display panel driving method greatly enhances the discharge probability of address discharge without increasing an address period. A unit display period of an input video signal is divided into a plurality of subfields. The address stage in one subfield of each unit display period induces normal address discharge in one discharge cell and also induces forced address discharge in another discharge cell adjacent to said one discharge cell in the column direction of the screen upon application of a pixel data pulse for said one discharge cell. To this end, the address stage applies a scanning pulse to each of row electrodes to be scanned consecutively in an overlapping manner for a predetermined period.

### BACKGROUND OF THE INVENTION

1. Field of the Invention

The present invention relates to a method of driving a plasma display panel in accordance with input video signals.

2. Description of the Related Art

Recently, plasma display apparatuses are commercialized as large-screen thin display devices. The plasma display apparatus is equipped with a plasma display panel (hereinafter called “PDP”). In the PDP, discharge cells corresponding to pixels are arranged in a matrix form.

In the PDP, a plurality of row electrodes corresponding to display lines are arranged in such a way as to intersect with a plurality of column electrodes vertically extending. “Vertically means in the height direction (or column direction) of the screen. The display lines extend horizontally (or in a row direction). Discharge cells are provided at intersections of the row electrodes and column electrodes. Each discharge cell has a discharge space filled with discharge gas.

The plasma display apparatus drives the PDP based on the subfield method, thereby creating various types of halftone luminance in accordance with input video signals.

In the driving scheme based on the subfield method, a display period of one field or one frame (hereinafter called “unit display period”) is divided into a plurality of subfields to which different light emission periods are allotted respectively, and an address stage and sustain stage are performed sequentially in each subfield.

In the address stage, while a scanning pulse is applied selectively to the row electrodes, a pixel data pulse according to an input video signal is applied sequentially to the column electrodes, display line by display line, thereby inducing selective address discharge in the discharge cells and setting each discharge cell to either a lighting mode or an unlighting mode. Next, in the sustain stage, only the discharge cells set to the lighting mode repeatedly perform sustain discharge for a light emission period assigned to the subfield concerned, so that a light emission state created by this sustain discharge is maintained for a particular period. By such driving, halftone luminance is viewed. The halftone luminance corresponds to a total period of sustain discharge generated in the subfields within the unit display period. It is therefore possible to create various types of halftone luminance at gradation levels corresponding to the number of the subfields defined in the unit display period.

In order to induce various types of discharge in the discharge cells, it is necessary to apply to the discharge cells a voltage exceeding a discharge start voltage. Whether discharge is really generated or not upon application of a voltage exceeding the discharge start voltage is dependent on a period during which the voltage is applied. In other words, the longer the period to continuously apply a voltage to a discharge cell is, the higher the probability of discharge to be generated in this discharge cell becomes. For example, in the address stage, if a pulse width of a scanning pulse and a pulse width of a pixel data pulse become greater to generate address discharge in the discharge cells, the success probability of address discharge becomes higher. However, if the pulses width of the scanning pulse and pixel data pulse become longer, a period used for the address stage becomes longer. As a result, the total period of the sustain discharge, which is generated within the unit display period, is shortened by the elongation of the address period. This reduces luminance.

In order to prevent the luminance decrease, time spent for the address period is shortened, by superposing in terms of time, one scanning pulse on another scanning pulse to be applied next in the address stage (see FIG. 5 of Japanese Patent Application Publication (Kokai) No. 2003-345289). At certain time t before the end of application of the scanning pulse As to the first display line, a scanning pulse As to the second display line starts to be applied. The time t during which the scanning pulse As to the first display line is superposed on the scanning pulse As to the second display line is smaller than a discharge delay time of the discharge cell, thereby preventing simultaneous writing in two display lines.

### SUMMARY OF THE INVENTION

However, if the superposing time t (extended portion of a scanning pulse width) is set to be shorter than the discharge delay time of the discharge cell to prevent the simultaneous writing in two display lines, it is impossible to increase the probability of address discharge.

One object of the present invention is to provide a method of driving a plasma display panel which can greatly enhance a probability of address discharge without increasing a period spent for an address period.

According to one aspect of the present invention, there is provided an improved method of driving a plasma display panel in a plurality of subfields for each unit display period of an input video signal, thereby to perform a gradation display. The plasma display panel has a plurality of row electrode pairs extending in a row direction and a plurality of column electrodes extending in a column direction and crisscrossing the row electrode pairs. A plurality of discharge cells are defined at intersections of the row electrode pairs and column electrodes. Each row electrode pair serves as each display line of the plasma display panel. The discharge cells serve as pixels. The driving method includes, in each subfield, an address stage of sequentially applying a scanning pulse to one row electrode in each row electrode pair at a predetermined scanning period. The address stage also applies to the column electrodes, a pixel data pulse responsible for each pixel in accordance with the input video signal for every scanning period, thereby inducing address discharge in the discharge cells so as to bring each of the discharge cells into a lighting mode or unlighting mode. The driving method also includes a sustain stage of repeatedly inducing discharge in only those discharge cells which are brought into the lighting mode, for a period corresponding to a luminance weight allotted to the subfield concerned. In the address stage in at least one of the subfields of the unit display period, the scanning pulses are sequentially applied to a first row electrode to which one discharge cell belongs and to a second row electrode belonging to a display line adjacent to the first row electrode in an overlapping manner for a predetermined period. Thus, the address discharge is generated in said one discharge cell and also in another discharge cell scanned immediately before said one discharge cell upon application of the pixel data pulse for said one discharge cell.

In the address stage of a certain subfield in the unit display period, the scanning pulses are supplied to the row electrodes, which are to be scanned sequentially, in an overlapping manner for a predetermined period. As a result, normal address discharge is generated in one discharge cell and forced address discharge is generated in another discharge cell adjacent in the column direction, upon application of the pixel data pulse for the one discharge cell.

The address discharge forcedly generated can provide electrically-charged particles in a sufficient amount required for discharge to occur next (i.e., discharge to occur in a target discharge cell). This results in increased discharge probability of the target discharge cell. Therefore, it is possible to securely generate address discharge in the target discharge cell. Because the scanning pulses continuously applied to the row electrodes for a period longer than the scanning period, wall charge can be formed securely after the address discharge without elongating the address stage time.

According to a second aspect of the present invention, there is provided another method of driving a plasma display panel in a plurality of subfields for each unit display period of an input video signal, thereby to perform a gradation display. The plasma display panel has a plurality of row electrode pairs extending in a row direction and a plurality of column electrodes extending in a column direction and crisscrossing the row electrode pairs such that a plurality of discharge cells are defined at intersections of the row electrode pairs and column electrodes. Each row electrode pair serves as each display line of the plasma display panel. The discharge cells serve as pixels. The driving method includes, in each subfield, an address stage of sequentially applying a scanning pulse to one row electrode in each row electrode pair at a predetermined scanning period, and applying to the column electrodes, a pixel data pulse responsible for each pixel in accordance with the input video signal for every scanning period, thereby inducing address discharge in the discharge cells so as to bring each discharge cell into a lighting mode or unlighting mode. The driving method also includes a sustain stage of repeatedly inducing discharge in only those discharge cells which are brought into the lighting mode, for a period corresponding to a luminance weight allotted to the subfield concerned. In the address stage in at least one subfield of the unit display period, the scanning pulses are sequentially applied to the row electrodes of first, second and third discharge cells adjacent to each other in the column direction in an overlapping manner for a predetermined period and a pulse width of the pixel data pulse is increased by an amount equivalent to the predetermined period. Thus, the address discharge is generated in the first, second and third discharge cells upon application of the pixel data pulse for the second discharge cell.

In the address stage of a certain subfield in the unit display period, the scanning pulses are supplied to the row electrodes, which are to be scanned sequentially, in an overlapping manner for a predetermined period. As a result, normal address discharge is generated in one discharge cell and forced address discharge is generated in another discharge cell adjacent in the column direction, upon application of the pixel data pulse for the one discharge cell.

The address discharge forcedly generated can provide electrically-charged particles in a sufficient amount required for discharge to occur next (i.e., discharge to occur in a target discharge cell). This results in increased discharge probability of the target discharge cell. Therefore, it is possible to securely generate address discharge in the target discharge cell. Because the scanning pulses continue to be applied to the row electrodes for a period longer than the scanning period, wall charge can be formed securely after the address discharge without elongating the address stage time.

These and other objects, aspects and advantages of the present invention will become apparent to those skilled in the art from the following detailed description and appended claims, when read and understood in conjunction with the accompanying drawings.

### BRIEF DESCRIPTION OF THE DRAWINGS

FIG. 1 illustrates a schematic configuration of a plasma display apparatus which is driven by a driving method according to one embodiment of the present invention;

FIG. 2 schematically illustrates an internal configuration of the PDP, viewed from a display screen side;

FIG. 3A is a cross-sectional view taken along the line III-III in FIG. 2;

FIG. 3B is similar to FIG. 3A and illustrates a modification to the structure shown in FIG. 3A;

FIG. 4 is a cross-sectional view taken along the line IV-IV in FIG. 2;

FIG. 5 schematically shows MgO crystal contained in the fluorescent material layer;

FIG. 6 shows an example of light emission patterns at various graduation levels in the plasma display apparatus shown in FIG. 1;

FIG. 7 shows an exemplary light emission drive sequence employed in the plasma display apparatus shown in FIG. 1;

FIG. 8 is a diagram showing various drive pulses to be applied to a PDP according to the light emission drive sequence shown in FIG. 7;

FIG. 9 illustrates an example of an addressing operation in the selective write addressing stage;

FIG. 10 illustrates another example of addressing operation in the selective write addressing stage;

FIG. 11 illustrates yet another example of addressing operation in the selective write addressing stage;

FIG. 12 illustrates a configuration of another plasma display apparatus which is driven by a driving method of a second embodiment of the present invention;

FIG. 13 shows an example of light emission patterns at various gradation levels in the plasma display apparatus shown in FIG. 12; and

FIG. 14 shows an example of a light emission driving sequence which is used in the plasma display apparatus shown in FIG. 12.

### DETAILED DESCRIPTION OF THE INVENTION

Embodiments of the present invention will be described in detail with reference to the accompanying drawings.

### First Embodiment

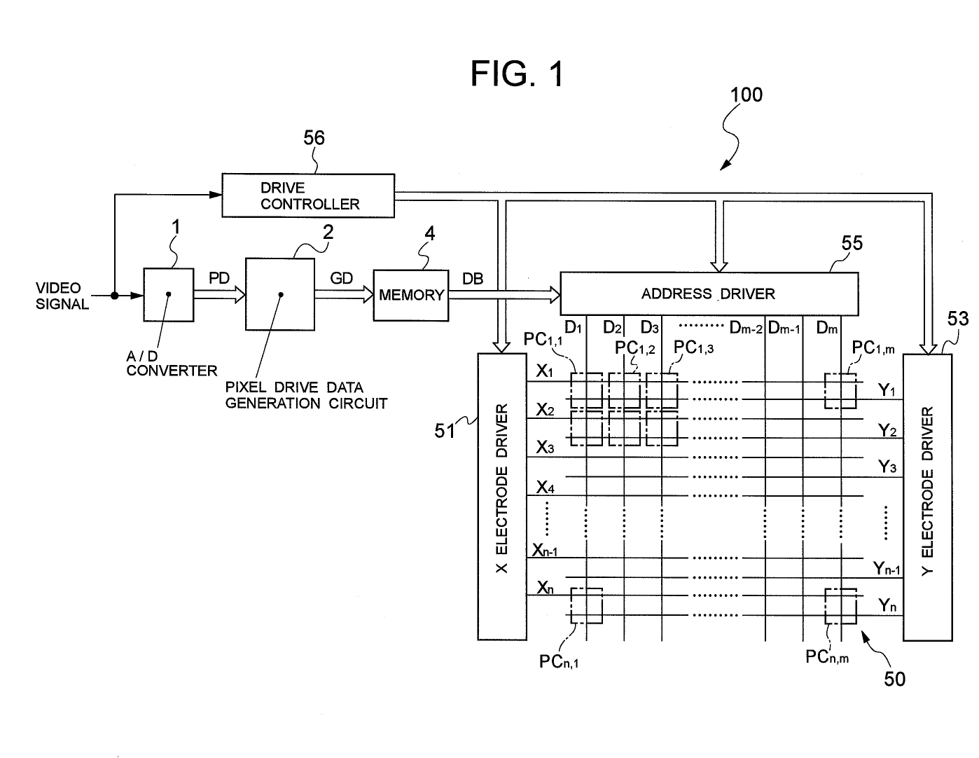

Referring to FIG. 1, a configuration of a plasma display apparatus 100 according to one embodiment of the present invention will be described.

As shown in FIG. 1, the plasma display panel apparatus 100 includes an A/D converter 1, a pixel driving data generator circuit 2, a memory 4, a PDP 50, an X electrode driver 51, a Y electrode driver 53, an address driver 55, and a driving control circuit 56.

In the PDP (plasma display panel) 50, provided are column electrodes D₁-Dₘ, which respectively extend in a screen height direction (vertical direction or column direction), and row electrodes X₁-Xₙ and row electrodes Y₁-Yₙ which respectively extend in a screen width direction (horizontal direction or row direction). Each two neighboring row electrodes Yi and Xi make a pair such that the row electrode pairs (Y₁, X₁), (Y₂, X₂), (Y₃, X₃) . . . , (Yₙ, Xₙ) define respectively the first display line to the n-th display line of the PDP 50. At intersections between each of the display lines and each of the column electrodes D₁-Dₘ (an area surrounded with the chain line in FIG. 1), formed are discharge cells (display cells) corresponding to pixels. In other words, in the PDP 50, arranged respectively in a matrix fashion are discharge cells PC_{1,1}-PC_{1,m}, which belong to the first display line, discharge cells PC_{2,1}-P_{2,m}, which belong to the second display line, . . . and discharge cells PC_{n,1}-PC_{n,m}, which belong to the n-th display line.

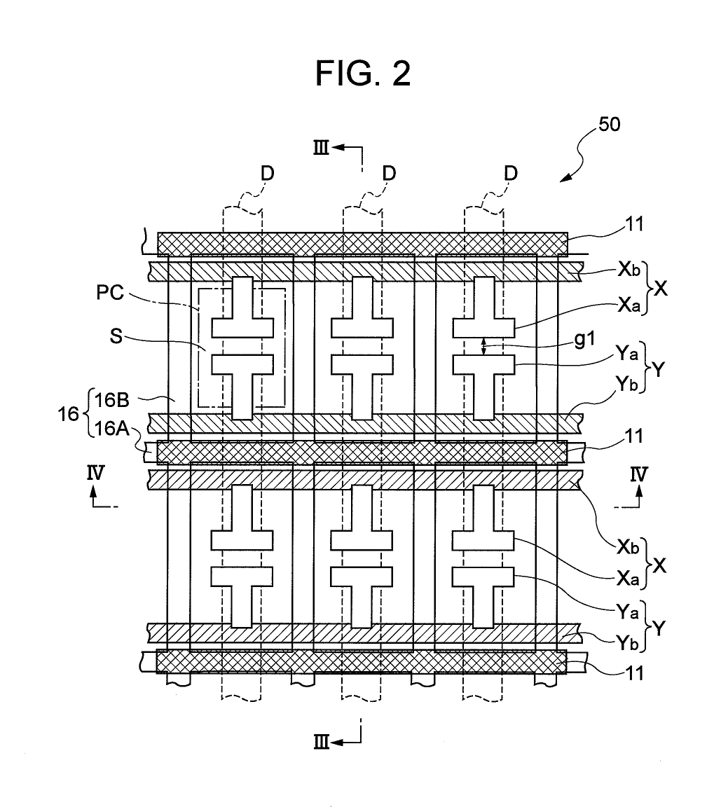

FIG. 2 illustrates the internal configuration of the PDP 50 when viewed from the front face side of the PDP 50. FIG. 2 shows, as an extract, the intersections between the three neighboring column electrodes D and the two neighboring display lines.

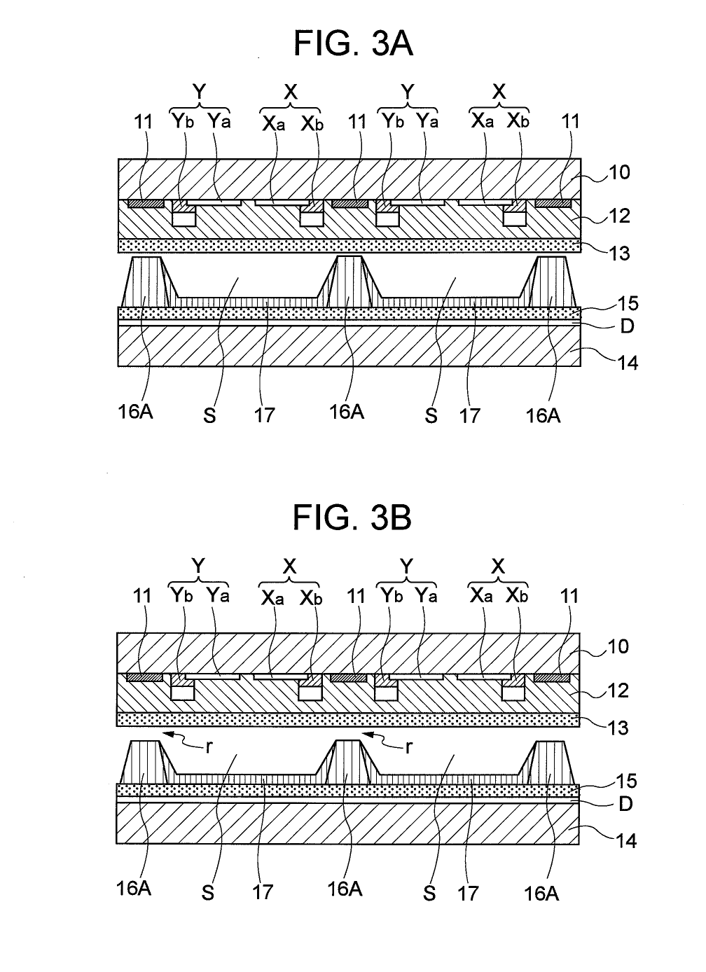

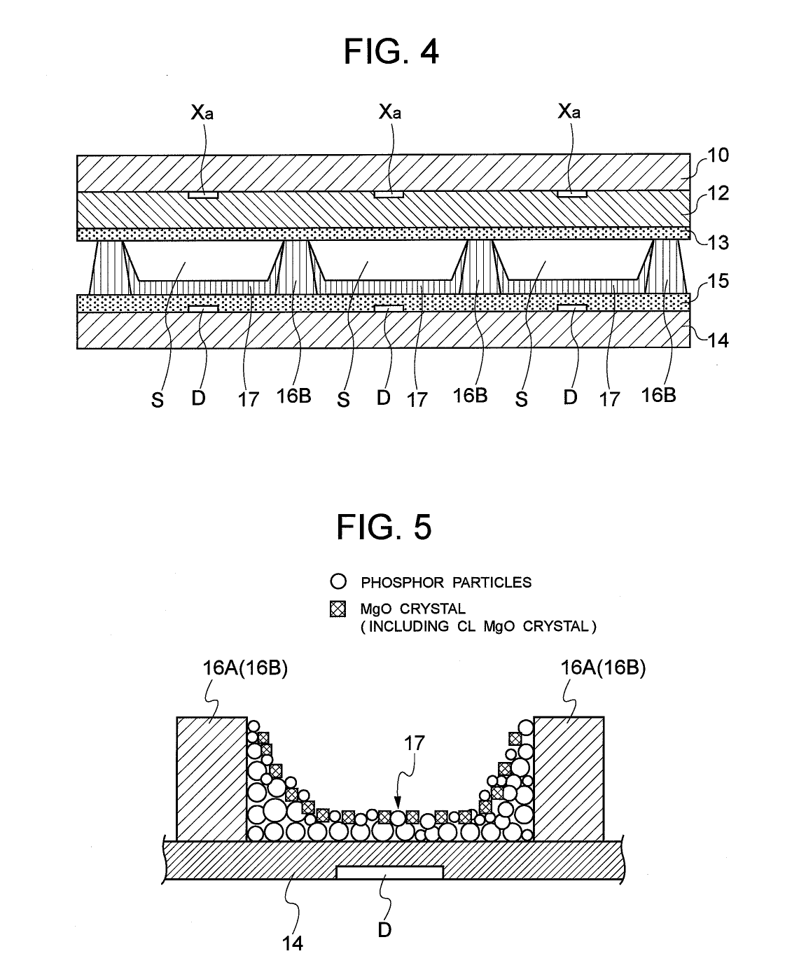

As shown in FIG. 2, each of the row electrodes X has a bus electrode Xb extending horizontally on the two-dimensional display screen, and T-shaped transparent electrodes Xa which are in contact with the bus electrode Xb. The T-shaped transparent electrodes Xa are provided at positions corresponding to the discharge cells PC on the bus electrode Xb. Each of the row electrodes Y has a bus electrode Yb extending horizontally on the two-dimensional display screen, and T-shaped transparent electrodes Ya which are in contact with the bus electrode Yb. The transparent electrodes Ya are provided positions corresponding to the discharge cell PC on the bus electrode Yb. The transparent electrodes Xa and Ya, for example, have a transparent conducting layer such as ITO, and the bus electrodes Xb and Yb have, for example, a metal film. The row electrodes X and Y are formed on the back side of the front-side transparent plate 10, of which front side is the screen surface side of the PDP 50, as shown in FIG. 3A. Looking at a pair of row electrodes X and Y, the transparent electrodes Xa extend toward the row electrode Y and the transparent electrodes Ya extend toward the row electrode X. The transparent electrodes Xa and Ya face each other and make pairs. Each transparent electrode has a large head at its end. A discharge gap g1 of a specified amount is formed between the facing transparent electrode Xa and Ya. Hereinafter, a combination of the row electrodes X and Y, to which the transparent electrodes Xa and Ya defining the discharge gap g1 belong, is called a row electrode pair (X, Y). On the back side of the front-side transparent plate 10 between one row electrode pair (X, Y) and an adjacent row electrode pair, formed is a black or dark-colored light absorption layer (light shielding layer) 11, which extends horizontally on the two-dimensional display screen. Also, on the back side of the front-side transparent plate 10, a dielectric layer 12 is formed in such a manner as to cover the row electrode pairs (X, Y). On the surface of the dielectric layer 12, a magnesium oxide layer 13 is formed. The magnesium oxide layer 13 contains a crystalline body of magnesium oxide as a secondary electron emission material for CL (cathode luminescence) light emission which has a peak in a wavelength range of 200-300 nm (preferably, 230-250 nm) upon excitation by electron irradiation (hereinafter called “CL light emission MgO crystalline body”). The CL light emission MgO crystalline body is obtained by subjecting magnesium vapor to vapor-phase oxidation. Magnesium vapor is generated by heating magnesium. The CL light emission MgO crystalline body has, for example, a multiple crystalline structure in which cubic crystalline bodies are fitted to each other, or a cubic single crystalline structure. The average particle size of the CL light emission MgO crystalline body is equal to or more than 2000 Angstroms (measured by BET method).

When a vapor-phase oxidation method is used to prepare magnesium oxide single crystalline body having a large grain diameter (i.e., MgO single crystal having an average particle size of 2000 Angstroms or more), a heating temperature should be high enough to generate magnesium vapor. Because of this, a flame generated by reaction of magnesium with oxygen becomes long, and the temperature difference between the flame and the environment becomes greater. As a result, the larger the particle size of the vapor-phase-method magnesium oxide single crystalline body is, the more often it is generated with an energy level corresponding to the above-mentioned CL light emission peak wavelength (for example, around 235 nm or 230-250 nm). In addition, the vapor-phase-method magnesium oxide single crystalline body has an energy level corresponding to the above-mentioned CL light emission peak wavelength, when it is generated by increasing the volume of magnesium to be vaporized per hour to enlarge the area of reaction with oxygen so as to permit reaction with more oxygen, in comparison with the common vapor-phase oxidation method.

The magnesium oxide layer 13 is formed on the dielectric layer 12 by the spray method, electrostatic coating method or the like. Specifically, by causing the above-described CL light emission MgO crystalline body to adhere to the surface of the dielectric layer 12 using the spray method or the like, the magnesium oxide layer 13 is formed. It should be noted that a thin-film magnesium oxide layer may be formed on the surface of the dielectric layer 12 by vapor deposition or by sputtering and then a CL light emission MgO crystalline body may be applied to the thin-film magnesium oxide layer to form the magnesium oxide layer 13 thereon.

On the back-side plate 14 arranged in parallel to the front-side transparent plate 10, the column electrodes D extend in a direction orthogonal to the row electrode pairs (X, Y) at positions of the transparent electrodes Xa and Ya when viewed from the front (see FIG. 2). When viewed in the cross-section (see FIG. 3A), the column electrodes D extend below the transparent electrodes Xa and Ya. Each column electrode D extends along the corresponding transparent electrodes Xa and Ya. On the rear plate 14, a white-colored column electrode protection layer 15 for covering the column electrodes D is formed. On the column electrode protection layer 15, formed is a partition wall 16. The partition wall 16 has lateral walls 16A and vertical walls 16B. The lateral (horizontal) walls 16A extend in a lateral (width) direction of the two-dimensional display screen. The lateral walls 16A extend between each two adjacent row electrode pairs (X, Y). The vertical walls 16B extend in the height direction of the two-dimensional display screen. The vertical walls 16B extend between each two adjacent column electrodes D. In an area surrounded by two lateral walls 16A and two vertical walls 16B, defined is a discharge cell PC including a discharge space S and the transparent electrodes Xa and Ya. The discharge space S of one discharge cell PC is independent from the discharge space S of an adjacent discharge cell PC. In the discharge cell S, discharge gases including xenon gas are filled. Between the lateral wall 16A and the surface of the magnesium oxide layer 13, formed there is a small interstice, through which mutual connection is made between discharge spaces of the discharge cells PC adjacent to each other in the height (vertical) direction of the two-dimensional display screen. This interstice is formed due to manufacturing irregularity in height of the lateral wall 16A and the vertical wall 16B and/or due to subtle concave-convex on the surface of the magnesium oxide layer 13. Alternatively, as shown in FIG. 3B, the lateral wall 16A may be made shorter by a specified amount than the vertical wall 16B to intentionally provide a relatively large gap r. Through the gap r, mutual connection (communication) may be made between the discharge spaces of the discharge cells PC adjacent to each other in the height direction of the two-dimensional display screen. It should be noted that the partition wall 16 may be formed with only the vertical walls 16B, without the lateral walls 16A.

On the lateral side of the lateral wall 16A, the lateral side of the vertical wall 16B, and the surface of the column electrode protection layer 15 in each of the discharge cells PC, to cover all of the foregoing, formed is a fluorescent material layer 17. This fluorescent material layer 17 has one of three fluorescent materials: a fluorescent material emitting a red color, a fluorescent material emitting a green color, and a fluorescent material emitting a blue color. For example, a red color emitting fluorescent material is applied on the fluorescent material layer 17 of each of the discharge cells PC belonging to the (3K-2)th column electrodes (D₁, D₄, D₇, D₁₀, . . . ), a green color emitting fluorescent material is applied on the fluorescent material layer 17 of each of the discharge cells PC belonging to the (3K-1)th column electrodes (D₂, D₅, D₈, D₁₁, . . . ), and a blue color emitting fluorescent material is applied on the fluorescent material layer 17 of each of the discharge cells PC belonging to the (3K)th column electrodes (D₃, D₆, D₉, D₁₂, . . . ). That is, on one column electrode D, discharge cells emitting one of the red, green and blue colors are arranged. The fluorescent material layer 17 contains a MgO crystalline body (including a CL light emission MgO crystal), and the MgO crystalline body serves as a secondary electron emission material. A part of the MgO crystalline body is exposed from the fluorescent material layer 17 so that it is in contact with discharge gas on the surface of the fluorescent material layer 17, i.e., it is in contact with the discharge space S on the surface of the fluorescent material layer 17. In this manner, the PDP 50 includes a CL light emission MgO crystalline body in both the magnesium oxide layer 13 and fluorescent material layer 17. Thus, discharge delay time is greatly reduced, and the discharge intensity becomes smaller, compared with the conventional PDP.

The A/D converter 1 samples an input video signal, converts it into pixel data PD, for example, of 8 bits, and supplies the pixel data PD to the pixel drive data generator circuit 2. The pixel data PD corresponds to each pixel.

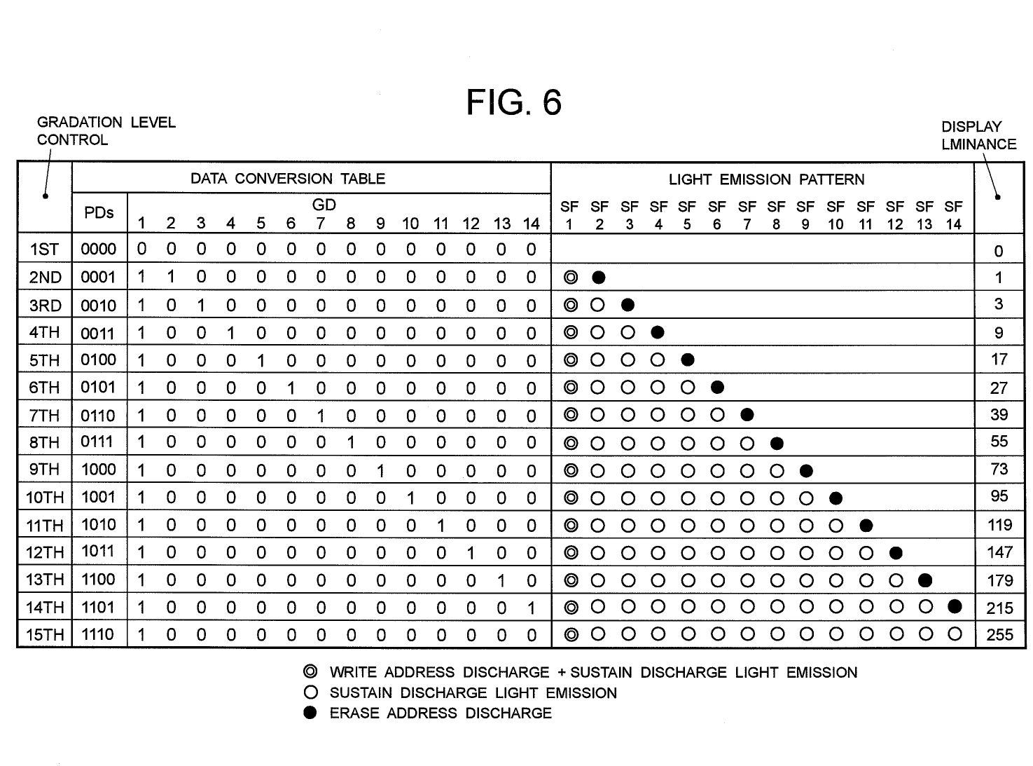

The pixel drive data generator circuit 2 first performs a gradation processing, which includes error diffusion processing and dither processing for the pixel data PD of each pixel. For example, in the error diffusion processing, the pixel drive data generator circuit 2 takes upper six bits of the pixel data as display data, and takes the remaining lower two bits as error data. The pixel drive data generator circuit 2 then obtains the error data in the pixel data of surrounding pixels, performs the weighting addition to the error data, and applies (reflects) the resulting error data on (in) the display data, thereby obtaining six-bit error-diffusion-processed pixel data. By such error diffusion processing, luminance of the lower two bits in an original pixel is expressed apparently (pseudo representation) by the surrounding pixels. Accordingly, the six-bit display data can represent luminance gradation in the same manner as the eight-bit pixel data. The pixel drive data generator circuit 2 applies the dither processing on the error-diffusion-processed 6-bit pixel data. In the dither processing, a plurality of pixels adjacent to each other is taken as one pixel unit. To the error-diffusion-processed pixel data of pixels in one pixel unit, dither coefficients having coefficient values different from each other are allocated respectively and added, thereby obtaining the dither-added pixel data. If the pixel unit is looked at after the addition of the dither coefficients, upper 4 bits of the dither-added pixel data is only needed to represent luminance of 8-bit data. The pixel drive data generator circuit 2 extracts, for example, upper four bits from the dither-added pixel data, and makes it into 4-bit multiple level gradation pixel data PDs which is represented by dividing the luminance levels for each pixel into 15 levels (first to 15^{th} levels) as shown in FIG. 6. The pixel drive data generator circuit 2 converts sequentially the multiple gradation pixel data PDs of each pixel to 14-bit pixel drive data GD according to a data conversion table as shown in FIG. 6, and supplies it to the memory 4. The logical level for each of the first to the fourteenth bits in the pixel drive data GD indicates whether address discharge (described later) is generated or not in the subfield (described later) corresponding to the bit place concerned. The first bit of the pixel drive data GD corresponds to the start subfield, and the fourteenth bit corresponds to the end subfield. When the logical level of the bit in question is 1, address discharge is generated in the subfield corresponding to that bit, whereas when the logical level is 0, address discharge is not generated in the subfield corresponding to that bit.

The memory 4 sequentially writes the pixel drive data GD. The memory 4 performs the read operation (will be described) every time the writing of one-screen-worth of pixel drive data GD_{(1,1)}-GD_{(n,m)}, i.e., pixel drive data for the n×m pixels (the first row, first column to n-th row, m-th column), is finished.

First, the memory 4 judges the first bit in each of the pixel drive data GD_{(1,1)}-GD_{(n,m)} to be pixel drive data bit DB_{(1,1)}-DB_{(n,m)}, reads the pixel drive data bits, display line by display line, in the subfield SF1 (will be described later), and supplies them to the address driver 55. Next, the memory 4 judges the second bit in each of the pixel drive data GD_{(1,1)}-GD_{(n,m)} to be pixel drive data bits DB_{(1,1)}-DB_{(n,m)}, reads the pixel drive data bits, display line by display line, in the subfield SF2, and supplies them to the address driver 55. In the same manner, the memory 4 separates and reads the bits of the pixel drive data GD_{(1,1)}-GD_{(n,m)} for every bit place, and supplies them to the address driver 55 as pixel drive data bits DB_{(1,1)}-DB_{(n,m)} in the respective subfields based on the bit place.

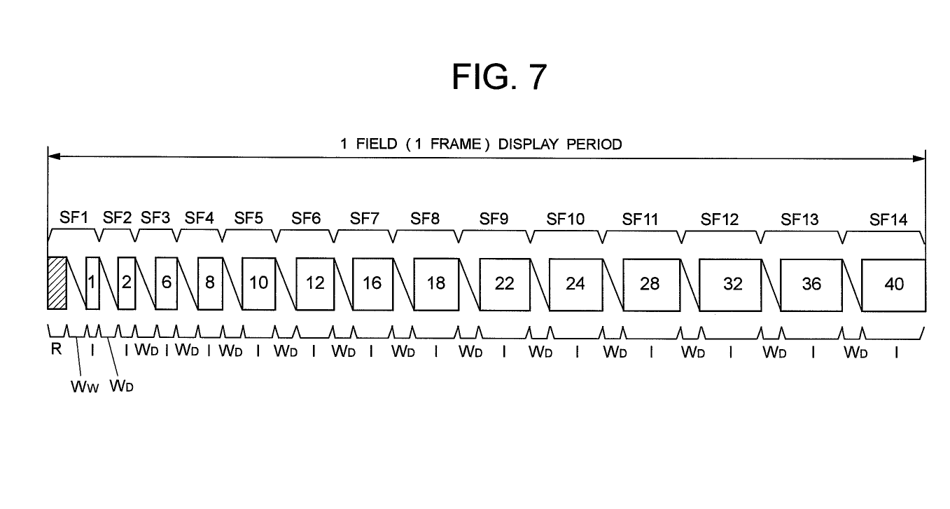

The drive control circuit 56 supplies various control signals to drive the PDP 50, according to a light emission sequence using the subfield method (subframe method) as shown in FIG. 7, to a panel driver module. The panel drive module includes an X electrode driver 51, Y electrode driver 53 and address driver 55. A display period for one field (one frame) consists of fourteen subfields SF1 to SF14 in this embodiment.

As shown in FIG. 7, the drive control circuit 56 supplies to the panel driver module, control signals to sequentially perform desired driving on the basis of the reset stage R, selective write address stage Ww and sustain stage I in the subfield SF1. In each of the subfields SF2-SF14, the drive control circuit 56 supplies to the panel driver module, control signals to perform driving on the basis of the selective erase address stage W_{D} and sustain stage I, respectively.

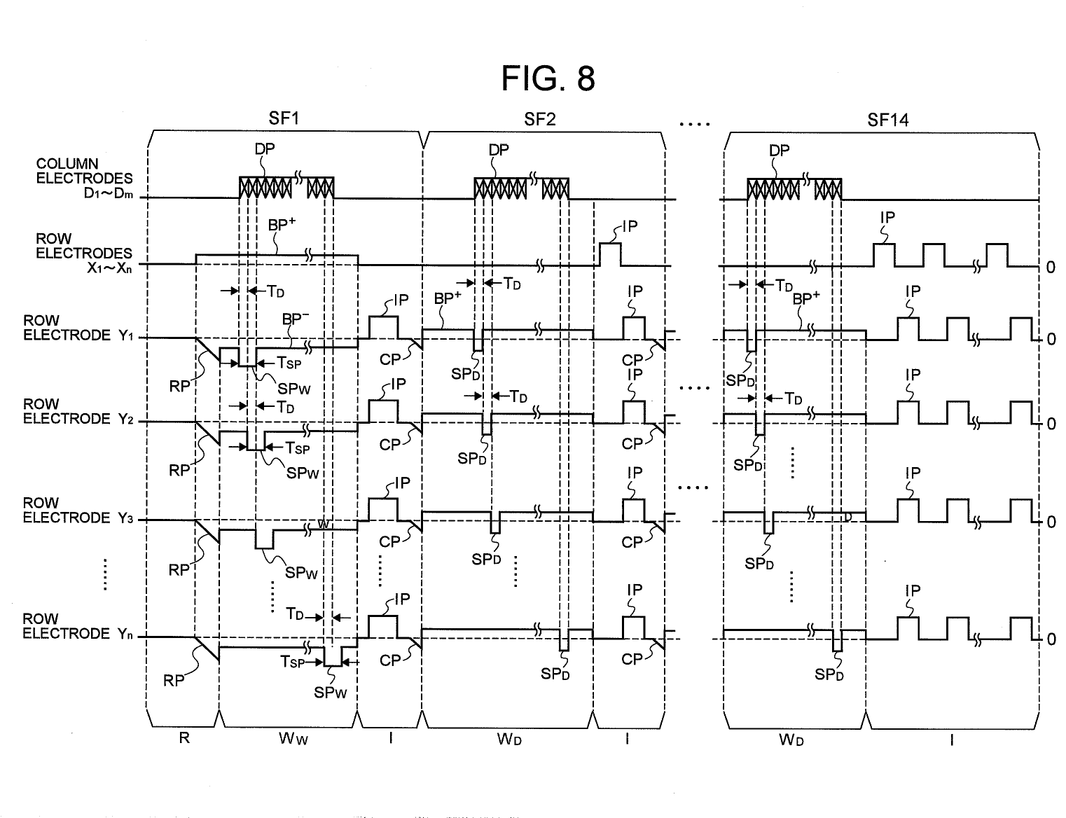

The panel drivers, namely, X electrode driver 51, Y electrode driver 53 and address driver 55, generate various drive pulses, as shown in FIG. 8, in correspondence with the control signals supplied from the drive control circuit 56, and applies them to the column electrode D, row electrodes X and row electrodes Y of the PDP 50. It should be noted that FIG. 8 illustrates only the operation in the first subfield SF1, second subfield SF2, and the last subfield SF14, among the subfields SF1-SF14 shown in FIG. 7.

In the reset stage R of the subfield SF1, the Y electrode driver 53 generates a reset pulse RP having a negative-polarity peak potential. The potential transition of the reset pulse RP at the front edge is gentle. The Y electrode driver 53 applies the reset pulse RP to all of the row electrodes Y₁-Yₙ. In the reset stage R, the X electrode driver 51 also applies to the row electrodes X₁-Xₙ, respectively, a base pulse BP⁺ having positive-polarity peak potential while the reset pulse RP is being applied to the row electrodes Y. As the negative-polarity reset pulse RP and positive-polarity base pulse BP⁺ are applied, weak (slight) reset discharge is generated between the row electrodes X and Y in all the discharge cells PC. The second reset discharge erases (eliminates) large portion of wall charge formed near the row electrodes X and Y of all the discharge cells PC. This brings all the discharge cell PC into a condition where there is a small (slight) amount of negative-polarity wall charge remaining near the row electrodes X, and a small amount of positive-polarity wall charge remaining near the row electrodes Y. In other words, all the discharge cells PC are initialized to unlighting mode. Upon application of the reset pulse RP, weak discharge is also generated between the row electrode Y and column electrode D in each discharge cell PC, and a portion of positive-polarity wall charge formed near the column electrode is erased (eliminated). Consequently, the wall charge remaining near the column electrode D in each discharge cell PC is adjusted to an amount which enables proper occurrence of the selective write address discharge in the selective write address stage Ww. The negative-polarity peak potential of the reset pulse RP is set to a potential higher than a peak potential of the negative-polarity write scanning pulse SPw. More specifically, it is set to a potential near 0 volt. If the peak potential of the reset pulse RP is lower than that of the write scanning pulse SPw, strong discharge is induced between the row electrode Y and column electrode D. This erases a large amount of wall charge near the column electrode D and disables appropriate address discharge in the selective write address stage Ww.

In the selective write address stage Ww in the subfield SF1, the Y electrode driver 53 applies simultaneously to each of the row electrodes Y₁-Yₙ a base pulse BP⁻ having negative-polarity peak potential, as shown in FIG. 8, and applies sequentially to each of the row electrodes Y₁-Yₙ the write scanning pulse SPw having a negative-polarity peak potential for every scanning period T_{D}. During this period, the X electrode driver 51 continues to apply the base pulse BP⁺ to the row electrodes X₁-Xₙ. The voltage applied between the row electrodes X and Y by the base pulses BP⁺ and BP⁻ is lower than discharge start voltage of the discharge cell PC.

In the selective write address stage Ww, the address driver 55 generates pixel data pulse PD having a peak potential in correspondence to the logical level of the first bit of the pixel drive data GD. The first bit corresponds to the first subfield SF1. For example, when a pixel drive data bit having a logical level 1, which sets the discharge cell PC to the lighting mode, is supplied, the address driver 55 converts it into a pixel data pulse DP having a positive-polarity peak potential. On the other hand, the address driver 55 produces a low-voltage (0 volt) pixel data pulse DP when the first bit of the pixel drive data GD has a logical level 0, which sets the discharge cell PC to the unlighting mode. The address driver 55 applies such pixel data pulse DP, display line by display line (m pixel data pulses DP at a time), to the column electrodes D1-Dm, in synchronism with the front edge of the respective write scanning pulse SPw. The selective write address discharge is generated between the column electrode D and row electrodes Y in the discharge cell PC if high-voltage pixel data pulse DP, together with the write scanning pulse SPw, is applied to that discharge cell PC. With such selective write address discharge, the discharge cell PC is set to a state in which positive-polarity wall charge is formed near the row electrode Y, negative-polarity wall charge is formed near the row electrode X, and positive-polarity wall charge is formed near the column electrode D. In other word, that discharge cell PC is set to the lighting mode. If low-voltage (0 bolt) pixel data pulse DP for the unlighting mode is applied together with the write scanning pulse SPw, the selective write address discharge is not generated between the column electrode D and row electrode X in the discharge cell PC. Hence, no discharge is generated between the row electrodes X and Y. Because of this, the discharge cell PC maintains the state immediately theretofore, i.e., the initialized state provided by the reset stage R or the unlighting mode.

In the sustain stage I of the subfield SF1, the Y electrode driver 53 generates a sustain pulse IP having positive-polarity peak potential, only by one pulse, and applies it to the respective row electrodes X₁-Xₙ simultaneously. During this time, the X electrode driver 51 sets the row electrodes X₁-Xₙ to a ground potential (0 volt), and the address driver 55 sets the column electrodes D₁-Dₘ to a ground potential (0 bolt). Upon application of the sustain pulse IP, sustain discharge is generated between the row electrodes X and Y in the discharge cell PC, which is set to the lighting mode. Light issued from the fluorescent material layer 17 upon such sustain discharge is irradiated to outside through the front transparent plate 10, and display lighting is made once in correspondence with the luminance weight of the subfield SF1. After application of the sustain pulse IP, the Y electrode driver 53 applies to the row electrodes Y₁-Yₙ, a wall charge adjusting pulse CP having a negative-polarity peak potential, as shown in FIG. 8. The wall charge adjusting pulse CP has gentle potential transition at the front edge, as depicted in FIG. 8. Upon application of the wall charge adjusting pulse CP, weak erasure discharge is generated in the discharge cell PC in which the sustain discharge is generated, and a portion of the wall charge formed in the discharge cell is erased. Consequently, the amount of the wall charge in the discharge cell PC is adjusted to an amount which enables proper selective erasure address discharge, in the next (succeeding) selective erasure address stage W_{D}.

In the selective erasure address stage W_{D} of the respective subfields SF₂-SF₁₄, the Y electrode driver 53 applies to the respective row electrodes Y₁-Yₙ a base pulse BP⁺ having positive-polarity peak potential while it applies sequentially to the row electrodes Y₁-Yₙ an erasure scanning pulse SP_{D} having negative-polarity peak potential, as shown in FIG. 8, for every scanning period T_{D}. The potential of the base pulse BP⁺ is set to a value that prevents erroneous discharge between the row electrodes X and Y during execution period of the selective erasure address stage W_{D}. During the execution period of the selective erasure address stage W_{D}, the X electrode driver 51 sets the row electrodes X₁-Xₙ to a ground potential (0 volt). In the selective erasure address stage W_{D}, the address driver 55 converts a pixel drive data bit corresponding to the subfield SF to a pixel data pulse DP having a peak voltage corresponding to the logical level thereof. For example, when a pixel drive data bit having a logical level “1” for changing the discharge cell PC from the lighting mode to the unlighting mode is supplied, the address driver 55 converts the pixel drive data bit to a pixel data pulse DP having a positive-polarity peak potential. On the other hand, when a pixel drive data bit having a logical level “0” to maintain the current state of the discharge cell PC is supplied, the address driver 55 converts the pixel drive data bit into a low-voltage (0 bolt) pixel data pulse PD. Then, the address driver 55 applies the pixel data pulse DP, display line by display line (m pixel data pulses at a time), to the column electrodes D₁-Dₘ in synchronism with the front edges of the erasure scanning pulses SP_{D}. Between the column electrode D and row electrode Y in the discharge cell PC to which a high-voltage positive-polarity pixel data pulse DP is applied, selective erasure address discharge is generated at the same time as the erasure scanning pulse SP_{D} is applied. With such selective erasure address discharge, the discharge cell PC is set to a state in which positive-polarity wall charge is formed near each of the row electrodes X and Y, and negative-polarity wall charge is formed near the column electrode D. In other word, the discharge cell PC is set to the unlighting mode. On the other hand, between the column electrode D and row electrode Y in the discharge cell PC to which a low-voltage (0 bolt) pixel data pulse DP is applied together with the erasure scanning pulse SP_{D}, the selective erasure address discharge is not generated. Therefore, the discharge cell PC maintains a state immediately theretofore (lighting mode or unlighting mode).

In the sustain stage I of each of the subfields SF2-SF14, as shown in FIG. 8, the X electrode driver 51 and Y electrode driver 53 repeatedly and alternately apply a sustain pulse IP having positive-polarity peak potential to the row electrodes X₁-Xₙ and Y₁-Yₙ. How many times the sustain pulse application should be repeated is decided by the luminance weight of the subfield concerned. This number is even. The smallest luminance weight is allocated to the sustain stage I in the first subfield SF1, and the increasing luminance weight is allocated to the sustain stage I in the respective subsequent subfield SF2 to SF14. Each time such sustain pulse IP is applied, sustain discharge is generated between the row electrodes X and Y in the discharge cell PC which is set to the lighting mode. As a result of light emission from the fluorescent material layer 17 through the front transparent plate 10, accompanied with such sustain discharge, display light emission is made in number corresponding to the luminance weight of the subfield SF concerned. Negative-polarity wall charge is formed near the row electrode Y and positive-polarity wall charge is formed near the row electrode X and column electrode D in the discharge cell PC in which sustain discharge is generated upon last application of the sustain pulse IP in the sustain stage I in each of the subfields SF2-SF14. After application of the last sustain pulse IP, as shown in FIG. 8, the Y electrode driver 53 applies to the row electrodes Y₁-Yₙ a wall charge adjusting pulse CP having negative-polarity peak potential. The wall charge adjusting pulse CP has gentle potential transition at the front edge. With application of such wall charge adjusting pulse CP, weak erasure discharge is generated in the discharge cell PC in which the sustain discharge is generated, and a portion of wall charge formed inside thereof is erased. Thus, the amount of the wall charge in the discharge cell PC is adjusted to an amount ensuring adequate selective erasure address discharge in a succeeding selective erasure address stage W_{D}.

The above-described driving is executed according to fifteen combinations of the pixel drive data GD, as shown in FIG. 6. With such driving (FIG. 6), except when representing a luminance level of 0 (first gradation level), write address discharge is generated in each discharge cell PC (marked with a double circle) in the first subfield SF1, and then the discharge cell PC is set to the lighting mode. Thereafter, selective erasure address discharge is generated only in the selective erasure address stage W_{D} in one of the subfields SF2-SF14 (marked with a black circle), and then the discharge cell PC is set to the unlighting mode. In this manner, each discharge cell PC is set to the lighting mode in each of the continuous subfields corresponding to a halftone luminance to represent, and repeatedly emits light by means of the sustain discharge for the numbers assigned to each of the subfields (marked with a white circle). As a result, luminance corresponding to a total number of sustain discharge generated in one field (or one frame) is viewed. Therefore, according to the 15 light emission patterns by use of the first to fifteenth levels of gradation shown in FIG. 6, fifteen levels of halftone luminance can be made, depending on the total number of sustain discharge generated in each of the subfields marked with a white circle.

In the driving scheme shown in FIGS. 6-8, initialization to the unlighting mode is made by inducing the reset discharge in all the discharge cells PC in the first subfield SF1, and transition to the lighting mode is made by generating the write address discharge (marked with a double circle) in each of the discharge cells PC, except when performing black display (first gradation level). When black display is made by such driving, discharge generated for the entire one field display period is only the reset discharge in the first subfield SF 1. Therefore, compared with the driving scheme that induces the rest discharge in all the discharge cells to bring the discharge cells into the lighting mode (initialization process) and induces selective erasure address discharge to bring them to the unlighting mode, the driving scheme of this embodiment is able to decrease the frequency (number) of discharge generated for one field display period. Thus, it is possible to improve a contrast when displaying dark image (so-called “dark contrast”).

In the driving shown in FIG. 8, the pulse width T_{SP} of the selective write scanning pulse SPw (scanning pulse) is approximately twice a scanning period T_{D} (for example, 1 μsec) in the selective write address stage Ww of the first subfield SF1. Therefore, the selective write scanning pulse SPw to be applied to one row electrode Y and the selective write scanning pulse SPw to be applied to another row electrode Y in a next discharge cell in the height direction of the display screen (or in the column direction) are superposed for a prescribed period (T_{D}).

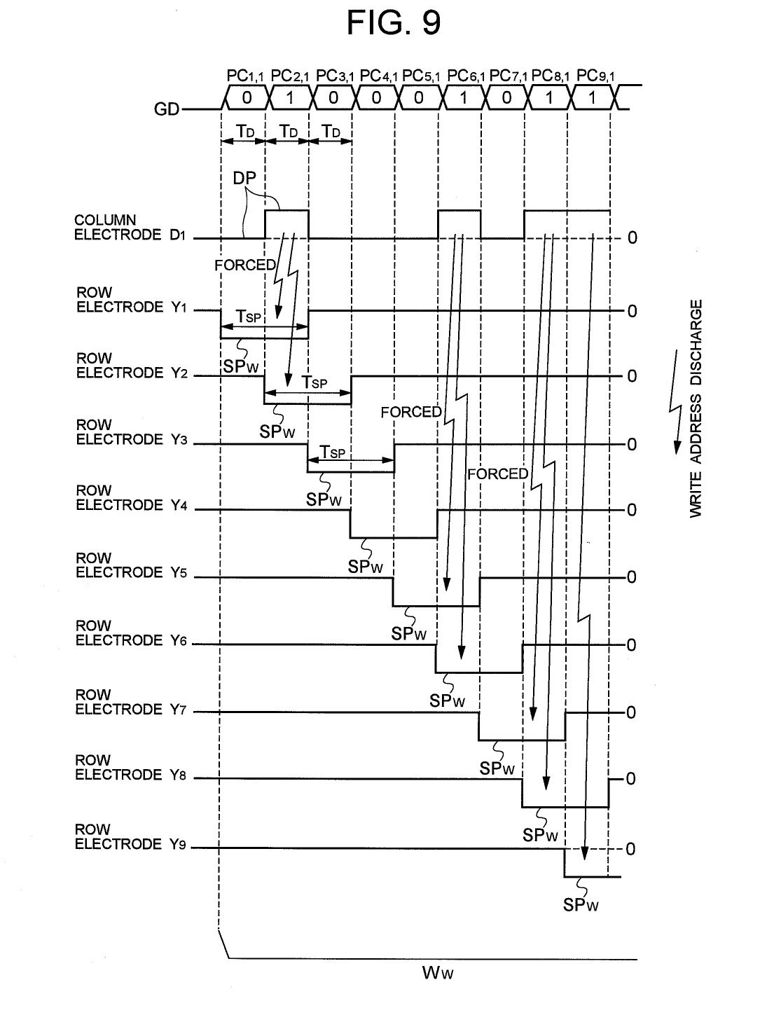

FIG. 9 shows an exemplary application of the pixel data pulse DP and selective write scanning pulse SPw in the selective write address stage Ww of the subfield SF1. For the sake of simplicity, a column electrode D₁ and row electrodes Y₁-Y₉ are extracted from the PDP 50. FIG. 9 shows a case of operation when pixel drive data GD having a bit series of [0,1,0,0,0,1,0,1,1] is supplied as the first bit of the pixel drive data GD corresponding to the discharge cells PC_{1,1}-PC_{9,1} formed at the intersections between the row electrodes Y1-Y9 and column electrode D1.

In FIG. 9, the Y electrode driver 53 generates a negative-polarity selective write scanning pulse SPw which has the pulse width T_{SP} for each scanning period T_{D}. The pulse width T_{SP} is twice the scanning period T_{D}. The Y electrode driver 53 sequentially applies the scanning pulse SPw to the row electrodes Y₁, Y₂, Y₃, . . . , Y₉. During this period, the address driver 55 sequentially generates pixel data pulses DP having the same pulse width as the scanning period TD and a peak potential corresponding to the logical level for each bit, and sequentially applies them to the column electrode D₁ in synchronism with a front edge of the selective write scanning pulse SPw, as shown in FIG. 9. Write address discharge is generated in those discharge cells PC to which a negative-polarity selective write scanning pulse SPw and positive-polarity high-voltage pixel data pulse DP are simultaneously applied, and these discharge cells PC are shifted to the lighting mode. On the other hand, the write address discharge is not generated in those discharge cells PC to which a low-voltage (0 bolt) pixel data pulse DP is applied together with a negative-polarity selective write scanning pulse SPw. Such discharge cells PC maintain a state immediately theretofore, i.e., unlighting mode state.

According to the pixel drive data GD having bit series of [0,1,0,0,0,1,0,1,1] as shown in FIG. 9, the write address discharge is generated in each of those discharge cells which correspond to the bit having a logical level “1,” i.e.,

PC_{2,1}: Discharge cell at an intersection of the column electrode D₁ and row electrode Y₂

PC_{6,1}: Discharge cell at an intersection of the column electrode D₁ and row electrode Y₆

PC_{8,1}: Discharge cell at an intersection of the column electrode D₁ and row electrode Y₈

PC_{9,1}: Discharge cell at an intersection of the column electrode D₁ and row electrode Y₈

On the other hand, write address discharge is not generated (theoretically) in each of those discharge cells which correspond to the bit having a logical level “0,” i.e.,

PC_{1,1}: Discharge cell at an intersection of the column electrode D₁ and row electrode Y₁

PC_{3,1}: Discharge cell at an intersection of the column electrode D₁ and row electrode Y₃

PC_{4,1}: Discharge cell at an intersection of the column electrode D₁ and row electrode Y₄

PC_{5,1}: Discharge cell at an intersection of the column electrode D₁ and row electrode Y₅

PC_{7,1}: Discharge cell at an intersection of the column electrode D₁ and row electrode Y₇

In the discharge space of the discharge cell PC, electrically-charged particles are formed each time discharge is generated, which increases a discharge probability. However, if discharge stops, the amount of the electrically-charged particles gradually decreases with the lapse of time, which decreases a discharge probability. For example, if the discharge cells are driven according to the pixel drive data GD shown in FIG. 9, and write address discharge is generated in the discharge cell PC_{9,1}, then write address discharge is generated also in the upstream (upper) discharge cell PC_{8,1}. The preceding (upstream) discharge ensures (provides) electrically-charged particles in an amount sufficient for the discharge in question. Therefore, in the discharge cell PC_{9,1}, it is possible to securely generate the write address discharge. However, if the discharge cell PC_{2,1} (or PC_{6,1} or PC_{9,1}) is looked at, the write address discharge is not generated in the preceding stage (i.e., in the discharge cell PC_{1,1} (or PC_{5,1} or PC_{8,1})), and therefore the amount of electrically-charged particles decreases. Accordingly, the probability of the write address discharge in the discharge cell PC_{2,1} (or PC_{6,1} or PC_{9,1}) drops in comparison with the discharge cell PC_{9,1}.

This embodiment does not have such problem. As shown in FIG. 9, the pulse width TSP of the selective write scanning pulse SPw to be applied to each of the row electrodes Y is set to be approximately twice a scanning period TD thereof. In other words, to each of the row electrodes Y of the discharge cells which are adjacent in the column direction and to be scanned sequentially, the selective write scanning pulses SPw are superposed for a specified period, i.e., the scanning period TD. Specifically, the superposing time (T_{D}) for the two selective write scanning pulses SPw, which are applied to the two row electrodes of the two discharge cells neighboring in the column direction, that is, to the upstream and downstream row electrodes Y, is longer than a minimum discharge delay time expected in the discharge cells. Thus, in response to application of the pixel data pulse DP to one discharge cell PC, address operation for forced generation of address discharge is executed also in another discharge cell upstream of the discharge cell PC in question (i.e., the discharge cell placed on the immediately upstream display line) together with the address discharge in the discharge cell PC in question.

For example, in FIG. 9, the pixel drive data GD (first bit) corresponding to the discharge cell PC_{1,1} at the intersection of the column electrode D₁ and row electrode Y₁ has a logical level of 0, and the pixel drive data GD (first bit) corresponding to the discharge cell PC_{2,1} which is subjected to scanning immediately after the discharge cell PC_{1,1} has a logical level of 1. Therefore, while a low-voltage (0 bolt) pixel data pulse DP based on a pixel drive data GD having the logical level of 0, corresponding to the discharge cell PC_{1,1}, is applied to the column electrode D1, write address discharge is not generated in the discharge cell PC_{1,1} at the intersection between the column electrode D₁ and row electrode Y₁, even when a negative-polarity selective write scanning pulse SPw is applied to the row electrode Y₁. On the other hand, if a high-voltage pixel data pulse DP, based on the pixel drive data GD having the logical level of 1, corresponding to the discharge cell PC_{2,1} which is subjected to scanning after the discharge cell PC_{1,1}, is applied to the column electrode D₁, write address discharge is generated in the discharge cell PC_{1,1} at the intersection between the column electrode D₁ and row electrode Y₁.

In other words, by applying the selective write scanning pulse SPw to each of the two row electrodes Y, which are adjacent in the column direction and are subjected to scanning sequentially, in the overlapping manner for the predetermined period (i.e., scanning period T_{D}), the write address discharge is forcedly generated in the upstream discharge cell (PC_{1,1}, PC_{5,1}, PC_{7,1}, PC_{8,1}) in addition to the write address discharge to be generated in the downstream discharge cell (PC_{2,1}, PC_{6,1}, PC_{8,1}, PC_{9,1}), regardless of the pixel drive data. With such write address discharge forcedly generated, the electrically-charged particles are obtained in an amount sufficient for the discharge in the discharge cell in question (PC_{2,1}, PC_{6,1}, PC_{8,1}, PC_{9,1}). Thus, in the target discharge cells (PC_{2,1}, PC_{6,1}, PC_{8,1}, PC_{9,1}) or the discharge cells in which write address discharge should occur, write address discharge is securely generated. With such driving, high peak voltage by the selective write scanning pulse SPw is applied to each of the row electrodes for a period longer than the scanning period T_{D} by the predetermined overlapping period (T_{D}). Hence, it is possible to form a wall charge in an amount enough to bring the discharge cell to the lighting mode.

Therefore, without increasing the period used for the write address stage (Ww), which brings the discharge cell to the lighting mode by forming the wall charge in the discharge cell upon executing selective discharge (write address discharge) in the discharge cell, it is possible to increase the discharge probability in address discharge and to securely provide a desired amount of wall charge.

There may be a case where discharge is not generated in the discharge cells (PC_{1,1}, PC_{5,1}, PC_{7,1}, PC_{8,1}) which are forcibly subjected to write address discharge. Even in such a case, the voltage applied in order to forcibly induce the write address discharge increases the discharge probability in the target discharge cells (PC_{2,1}, PC_{6,1}, PC_{8,1}, PC_{9,1}). In the driving described above, the forced discharge takes place in the discharge cells arranged in the same column electrode as the target discharge cells, and hence the upstream discharge cells (PC_{1,1}, PC_{5,1}, PC_{7,1}, PC_{8,1}) are assigned the same color light emission as the target downstream discharge cells (PC_{2,1}, PC_{6,1}, PC_{8,1}, PC_{9,1}). Because there is no error (difference) in terms of color, erroneous light emission caused by the forced discharge is hardly recognized by a viewer.

With such driving as described above, some discharge cells PC are forcedly set to the lighting mode, regardless of the pixel drive data GD, and hence there occurs a case where image corresponding to an input video signal cannot be displayed accurately.

Hence, in the above-described embodiment, the pulse width of the scanning pulse (SPw) is made twice the application period of the pixel data pulse DP only in the address stage (Ww) of the subfield SF1. Among the subfields SF1-SF14, as shown in FIG. 7, the subfield SF1 is unique because deterioration in image quality is relatively invisible and the allocated luminance weight is minimal.

As understood from FIGS. 8 and 9, in the selective write address stage Ww of the subfield SF1, the pulse width of the selective write scanning pulse SPw is elongated to approximately twice the scanning period T_{D}. It should be noted that the pulse width of the pixel data pulse DP corresponding to each discharge cell can also be approximately twice the scanning period T_{D}.

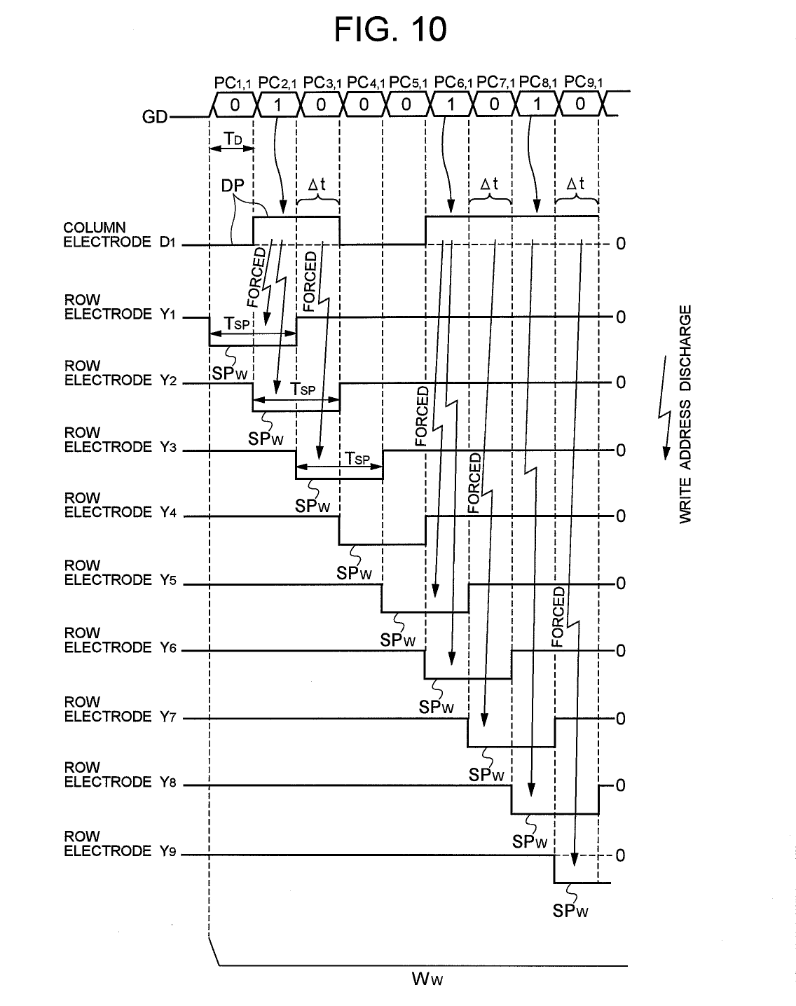

FIG. 10 illustrates an example where the pulse width of the pixel data pulse DP is also elongated to an approximate double of the scanning period T_{D}. As shown in FIG. 10, application of the pixel data pulse DP and selective write scanning pulse SPw in the selective write address stage Ww in the subfield SF1 is modified, as compared with FIGS. 8 and 9.

Similar to FIG. 9, FIG. 10 only shows the operation of the row electrodes Y₁-Y₉ and column electrode D₁ in the PDP 50. [0,1,0,0,0,1,0,1,0] are supplied as the first bit (bit series) of the pixel drive data GD corresponding to the discharge cells PC_{1,1}-PC_{9,1} formed between the row electrodes Y₁-Y₉ and column electrode D₁.

In FIG. 10, the Y electrode driver 53 generates a negative-polarity selective write scanning pulse SPw having a pulse width T_{SP}, which is twice the scanning period T_{D}, for each scanning period T_{D}, and sequentially applies it to the row electrodes Y₁, Y₂, Y₃, . . . , Y₉. The address driver 55 sequentially generates a pixel data pulse DP having a peak potential corresponding the logical level of the bit concerned, for each bit in a bit series comprised of the first bits of the pixel drive data GD, and sequentially applies it to the column electrode D₁ in synchronism with the front edge of the selective write scanning pulse SPw, as shown in FIG. 10. The address driver 55 generates, when a bit of the logical level 0 is supplied, the pixel data pulse DP having a low peak voltage (0 bolt) and a same pulse width as the scanning period T_{D}, and applies it to the column electrode D₁. On the other hand, when a bit of the logical level 1 is supplied, the address driver 55 generates the pixel data pulse DP having positive-polarity high-peak voltage and a pulse width of approximately twice the scanning period T_{D}, and applies it to the column electrode D₁.

In FIG. 10, because the pixel drive data GD to the discharge cell PC_{1,1} has the logical level of 0, the address driver 55 applies to the column electrode D₁ the pixel data pulse DP having a low peak voltage and pulse width T_{D}. Next, because the pixel drive data GD to the discharge cell PC_{2,1} which is subjected to scanning immediately after the discharge cell PC_{1,1} has the logical level of 1, the address driver 55 applies to the column electrode D₁ the pixel data pulse DP having a positive-polarity high-peak voltage and pulse width 2_{TD}. In other words, when applying the pixel data pulse DP having a positive-polarity high-peak voltage for the discharge cell PC_{2,1}, regardless of the pixel drive data GD to the discharge cell PC_{3,1} which is next subjected to scanning, the pixel data pulse DP having a positive-polarity high peak voltage is also applied as the pixel data pulse DP for the discharge cell PC_{3,1}. That is, as shown in FIG. 10, the maintaining time of the peak voltage in the positive-polarity pixel data pulse DP to the discharge cell PC_{2,1} is extended by Δt (=T_{D}), and such pixel data pulse DP is applied to the column electrode D₁ as the pixel data pulse DP for the discharge PC_{3,1} which is next subjected to scanning. During this period, the Y electrode driver 53 sequentially applies to the row electrodes Y₁ to Y₉, a negative-polarity selective write scanning pulse SPw having the pulse width T_{SP} of twice the scanning period T_{D}, for every scanning period, as shown in FIG. 10. As a result, write address discharge is generated in those discharge cells PC to which a negative-polarity selective write scanning pulse SPw and a positive-polarity high-peak-voltage pixel data pulse DP are applied simultaneously, and these discharge cells PC are shifted to the lighting mode. On the other hand, in those discharge cells PC to which a negative-polarity selective write scanning pulse SPw is applied and a low-peak-voltage (0 bolt) pixel data pulse DP is applied simultaneously, write address discharge is not generated, and these discharge cells PC maintain a state immediately theretofore, i.e., unlighting mode state.

With such driving, the address discharge is forcedly induced in the discharge cells (PC_{1,1}, PC_{5,1}, PC_{7,1}) one display line above the target discharge cells (PC_{2,1}, PC_{6,1}, PC_{8,1}) and in the discharge cells (PC_{3,1}, PC_{7,1}, PC_{9,1}) one display line below the target discharge cells (PC_{2,1}, PC_{6,1}, PC_{8,1}) regardless of the pixel drive data. The target discharge cells are those discharge cells in which write address discharge should be induced based on the pixel drive data. Because of the write address discharge forcedly generated, electrically-charged particles are supplied from the spatially adjacent discharge cells. Thus, the electrically-charged particles are obtained in an amount required for discharge to occur in the target discharge cell(s), and the discharge probability of the target discharge cell(s) increases. Consequently, in the target discharge cells (PC_{2,1}, PC_{6,1}, PC_{8,1}) in which the write address discharge should occur, write address discharge is securely generated. With such driving, a positive-polarity pixel data pulse DP and selective write scanning pulse SPw, both of them having a pulse width of approximately twice the scanning period T_{D} (for example, 1 μsec), are applied to the target discharge cells (PC_{2,1}, PC_{6,1}, PC_{8,1}) at a same timing. Hence, even if write address discharge is not generated at the first-half period, write address discharge can be generated with high possibility at the second-half period (Δt). In comparison with the driving scheme of FIG. 9, the discharge probability of write address discharge is further increased in FIG. 10.

However, even if the driving of FIG. 10 is performed, some discharge cells PC are forcedly set to the lighting mode regardless of the pixel drive data GD. This sometimes makes it impossible to correctly display image in a manner faithful to an input video signal.

Hence, among the subfields SF1-SF14 (FIG. 7), only in the address stage (Ww) in the subfield SF1 of which allocated luminance weight is the smallest, the address operation of FIG. 10 is executed.

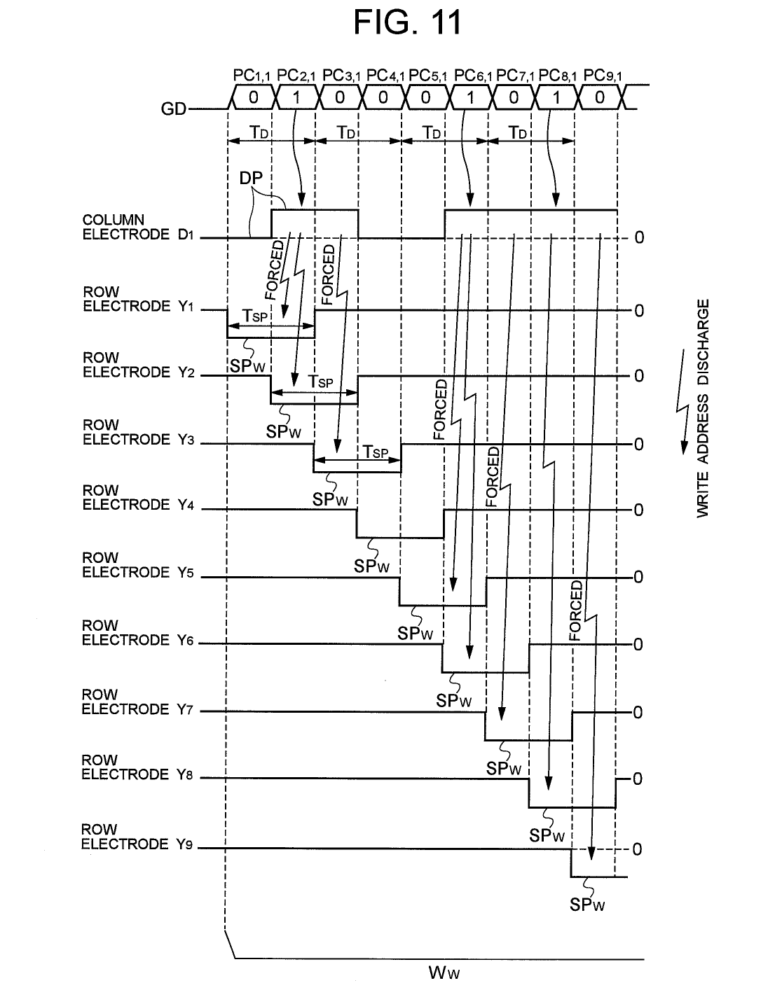

In the address operation shown in FIG. 10, the pulse width of the pixel data pulse DP and the pulse width of the selective write scanning pulse SFw are both approximately twice the scanning period T_{D}. It should be noted, however, that without any change to the pulse application format shown in FIG. 10, both the pixel data pulse DP and selective write scanning pulse SPw may have the same pulse width as the scanning period T_{D}, as shown in FIG. 11. The scanning period T_{D} is made double.

### Second Embodiment

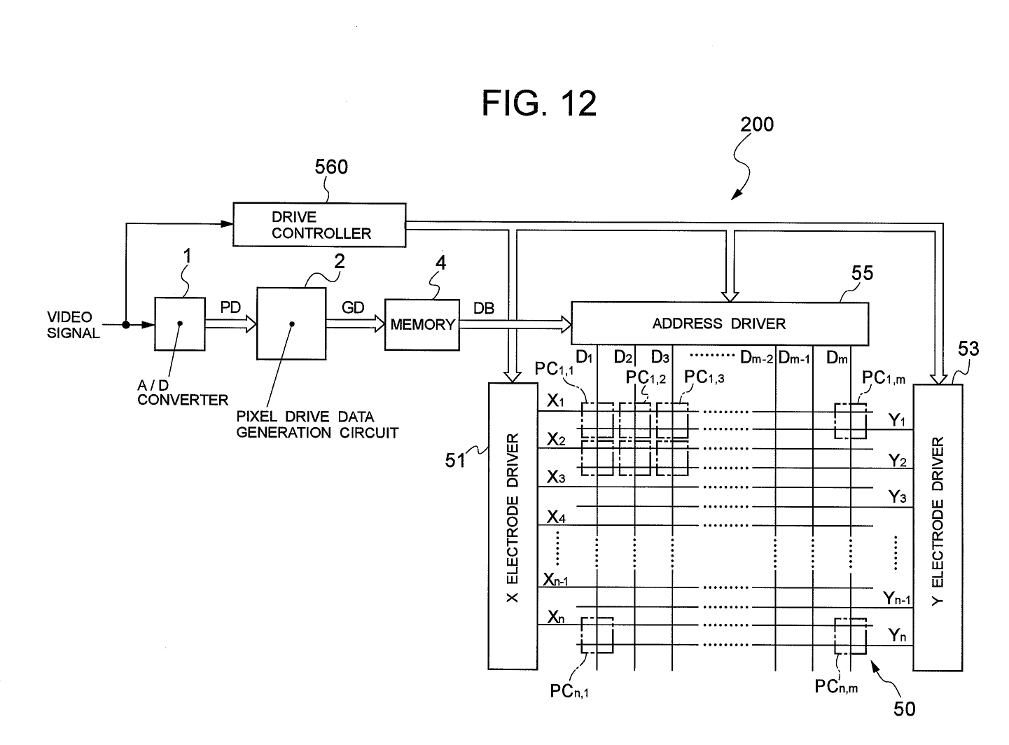

FIG. 12 shows another configuration of a plasma display apparatus 200 which has a plasma display panel (PDP) 50 to be operated according to a second embodiment of the driving method of the present invention.

The PDP 50 of the plasma display apparatus 200 has the same configuration as the PDP 50 shown in FIG. 1.

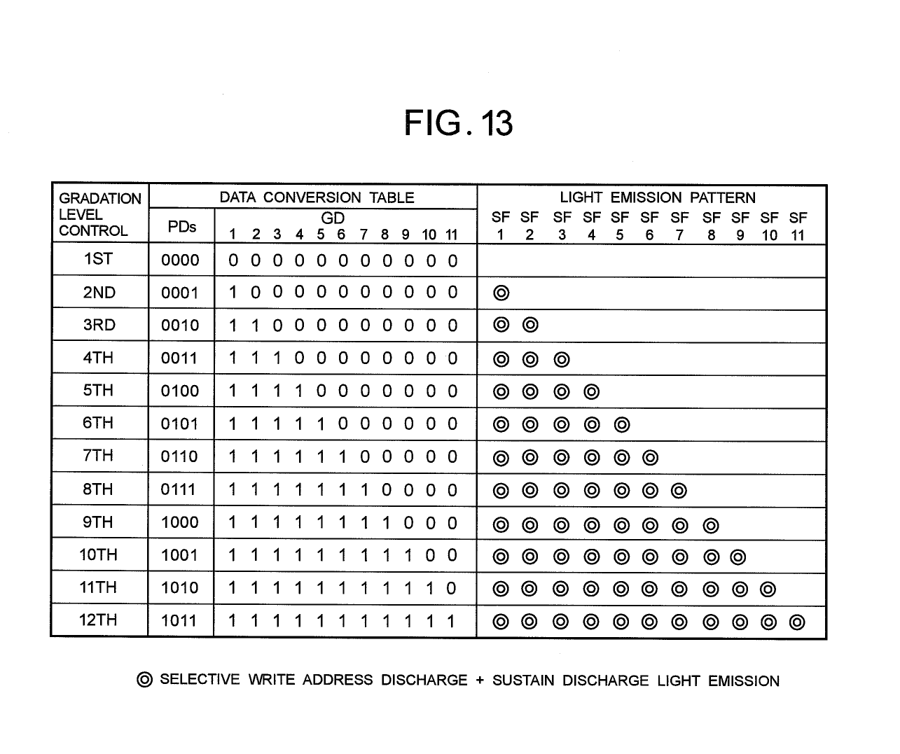

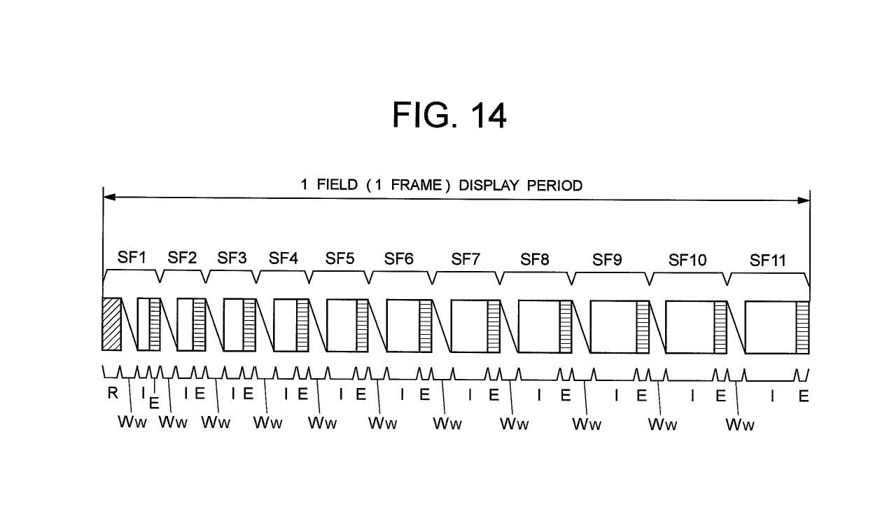

In FIG. 12, the A/D converter 1 converts an input video signal into pixel data PD, for example, of 8 bits, and supplies the pixel data PD to the pixel drive data generator circuit 20. The pixel data PD corresponds to the pixels. The pixel drive data generator circuit 20 performs a gradation processing including error diffusion processing and dither processing for each of the pixel data PD for each pixel. Such gradation processing is same as the processing performed in the pixel drive data generator circuit 2 (FIG. 1). By subjecting the pixel data PD to the gradation processing, the pixel drive data generator circuit 20 divides the entire luminance range to 12 levels (first to twelfth gradation levels), as shown in FIG. 13, and obtains 4-bit gradation pixel data PDs representing respective luminance levels thereof. The pixel drive data generator circuit 20 converts such gradation pixel data PDs into 11-bit pixel drive data GD according to a conversion table, as shown in FIG. 13, and supplies it to the memory 4. The logical level for each of the first to the eleventh bits in the pixel drive data GD shows whether address discharge (described later) is generated or not in the corresponding one of the subfields SF1-SF11 (FIG. 14). The first bit of the pixel drive data GD corresponds to the first subfield SF1, the second bit corresponds to the second subfield SF2, . . . , and the eleventh bit corresponds to the eleventh subfield SF11. When the logical level is 1, for example, the corresponding subfield generates address discharge. When the logical level is 0, the corresponding subfield does not generate the address discharge.

The memory 4 writes sequentially the pixel drive data GD. When one-screen-worth-of pixel drive data GD_{(1,1)}-GD_{(n,m)} are written, i.e., n×m pixel drive data GD corresponding to the pixels from the first row, first column to n-th row, m-th column are written, the memory 4 performs the read operation as described below.

First, the memory 4 judges the first bit in each of the pixel drive data GD_{(1,1)}-GD_{(n,m)} to be pixel drive data bit DB_{(1,1)}-DB_{(n,m)}, read them, display line by display line, in the subfield SF1, and supplies them to the address driver 55. Next, the memory 4 judges the second bit in each of the pixel drive data GD_{(1,1)}-GD_{(n,m)} to be pixel drive data bit DB_{(1,1)}-DB_{(n,m)}, read them, display line by display line, in the subfield SF2, and supplies them to the address driver 55. Below, in the same manner, the memory 4 classifies and reads each bit of the pixel drive data GD_{(1,1)}-GD_{(n,m)} with respect to the same bit place, and supplies them to the address driver 55 as pixel drive data bit DB_{(1,1)}-DB_{(n,m)}, respectively, in the subfield corresponding to the bit place.

The drive control circuit 560 supplies various control signals to drive the PDP 50, according to a light emission sequence using the subfield method (subframe method) as shown in FIG. 14, to panel drivers (namely, X electrode driver 51, Y electrode driver 53 and address driver 55). Specifically, the drive control circuit 560 supplies various control signals to the panel drivers so as to perform desired driving in each of the subfields SF1-SF11 for one field or one frame display period, based on the selective write address stage Ww, sustain stage I and the erasure stage E. The drive control circuit 560 supplies to the panel drivers, control signals to perform the reset driving, according to the reset stage R, prior to the selective write address stage Ww, only in the first subfield SF1 within the unit display period (each one frame or each one field).

The panel drivers (X electrode driver 51, Y electrode driver 53, address driver 55) drive the PDP 50 by applying various drive pulses to the column electrodes D, row electrodes X and row electrodes Y of the PDP 50, in accordance with the control signals supplied from the drive control circuit 560.

First, in the reset stage R which is performed only in the first subfield SF1, the Y electrode driver 53 applies a reset pulse to all of the row electrodes Y₁-Yₙ. With such application of the reset pulse, reset discharge is generated in all of the discharge cells PC. By such reset discharge, wall charge remaining near the row electrodes X and Y in each of the discharge cells PC is erased, and all of the discharge cells PC are initialized to the unlighting mode (unlit state).

Next, in the selective write address stage Ww in each of the subfields SF1-SF11, the address driver 55 generates a pixel data pulse (described later) having a peak voltage which corresponds to the logical level of the pixel drive data bit DB associated with to the subfield concerned, and sequentially applies them to the column electrodes D₁-Dₘ, display line by display line. Thus, m pixel drive data bit DB are applied to the m column electrodes D₁-Dₘ for each display line. For example, the address driver 55 generates a high-peak-voltage pixel data pulse when a pixel drive data bit DB has a logical level “1.” The logical level “1” indicates that the discharge cell should be set to the lighting mode. The address driver 55 generates a low-peak-voltage (0 volt, for example) pixel data pulse when the pixel drive data bit DB has a logical level is “0” that indicates that the discharge cell is set to the unlighting mode. During this period, the Y electrode driver 53 selectively applies write scanning pulses (described later) to the row electrodes Y₁-Yₙ in synchronism with each application timing of one-display-line-worth-of pixel data pulses. Selective write address discharge is generated between the column electrode D and the row electrode Y in those discharge cells PC to which high-peak-voltage pixel data pulse is applied simultaneously with the write scanning pulse. Accompanied with such discharge, the wall electric charge of a desired volume is formed in the discharge cell PC, and the discharge cell is set to the lighting mode. On the other hand, the selective write address discharge is not generated in those discharge cells to which low-peak-voltage pixel data pulse is applied simultaneously with the write scanning pulse. These discharge cells maintain the current mode, i.e., the unlighting mode is maintained.

Next, in the sustain stage I in each of the subfields SF1-SF11, the X electrode driver 51 and Y electrode driver 53 apply sustain pulses alternately to the row electrodes X and Y by the repetition frequency corresponding to the luminance weight of the subfield concerned. Each time the sustain pulse is applied, sustain discharge is generated between the row electrodes X and Yin the discharge cell PC of the lighting mode. Upon such sustain discharge, light from the fluorescent material layer 17 is irradiated to outside through the front transparent plate 10 so that display light emission is made (repeated) by the number corresponding to the luminance weight of the subfield SF. In the light emission drive sequence shown in FIG. 14, the nearer to the first subfield within the unit display period (one field display period), the smaller the luminance weight allocated to the subfield is.

In the erasure stage E in each of the subfields SF1-SF11, the Y electrode driver 53 applies erasure pulses to all the row electrodes Y₁-Yₙ. Upon application of such erasure pulses, erasure discharge is generated only in those discharge cells PC which are in the lighting mode. Such erasure discharge causes the discharge cells PC in the lighting mode to shift to the unlighting mode.

The above-described driving is performed on the basis of the 12 types of the pixel drive data GD as shown in FIG. 13. According to such driving (FIG. 13), except when the luminance level 0 is represented (first gradation level), write address discharge (marked with a double circle) is generated in the discharge cell PC in each of the subfields which are consecutive by a number corresponding to the luminance levels to represent, starting from the first subfield SF1, and the discharge cell PC is set to the lighting mode. Therefore, the discharge cell PC is set to the lighting mode in each of the subfields consecutive by the number corresponding to the halftone luminance to represent, and light emission accompanied with the sustain discharge is repeated by the number allotted to each of the subfields (marked with the double circle). Consequently, the luminance corresponding to the total sum of the sustain discharge generated within the unit display period is viewed. Therefore, according to the twelve types of the light emission patterns by the first to twelfth gradation level drive, as shown in FIG. 13, the twelve halftone luminances at the twelve gradation levels can be represented, which correspond to the total number of the sustain discharge generated in the subfields indicated with the double circle.

Among the subfields SF1-SF11, the subfields SF1-SF3 are used for low(er) luminance. In order to perform the driving shown in FIG. 14, the address operation is carried out in the selective write address stage Ww in each of the subfields SF1-SF3 in the form shown in FIG. 9, FIG. 10 or FIG. 11.

When the address operation shown in FIG. 9 is used, the pulse width of the write scanning pulse SPw to be sequentially applied to the row electrodes Y₁-Yₙ for each scanning period TD is set to be approximately twice the scanning period T_{D}. That is, with respect to each row electrode Y, two selective write scanning pulses SPw are overlapped for the scanning period TD. For example, the scanning pulse SPw for the row electrode Yl overlaps the scanning pulse SPw for the next row electrode Y₂ for the scanning period TD so that the two scanning pulses SPw are applied to the row electrode Y₂. When the address operation shown in FIG. 10 is used, not only the pulse width of the write scanning pulse SPw but also the pulse width of a high-peak-voltage pixel data pulse DP are set to be approximately twice the scanning period T_{D}. When the address operation shown in FIG. 11 is employed, the application form shown in FIG. 10 is maintained, and the pulse width of the pixel data pulse DP and the pulse width of the write scanning pulse SPw are both set to be half.

With such driving, write address discharge is forcedly generated in two discharge cells which are located up and down (in the column direction) of the discharge cell (target discharge cell) which should have the write address discharge according to the pixel drive data. This write address discharge is forcedly generated regardless of the pixel drive data. Because electrically-charged particles are supplied from the adjacent discharge cells due to the forcedly generated write address discharge, the electrically-charged particles are obtained in an amount required for discharge, which results in increased discharge probability of the discharge cell. Thus, write address discharge is securely generated in the discharge cell (target discharge cell) in which the write address discharge should occur. With such driving, a high-peak voltage of the selective write scanning pulse SPw is applied to each of the row electrodes Y during a period of approximately twice the scanning period T_{D}. Thus, a wall charge is formed in an amount enough to set the discharge cell to the lighting mode. Consequently, in a case where a wall charge is formed in a discharge cell by selectively inducing (triggering) the address discharge in the discharge cell to bring the discharge cell into the lighting mode, i.e.,where the so-called “selective write address method” is used, it is possible to increase the probability of address discharge and form a wall charge in a desired amount without elongating the address period Ww.

In the selective write address stage Ww, if the address operation is executed as shown in FIG. 9, FIG. 10 or FIG. 11, there is a case where it is not possible to correctly display image corresponding to an input video signal because some discharge cells are forcedly set to the lighting mode regardless of the pixel drive data GD.

For example, when one discharge cell PC is driven at the fourth gradation level (FIG. 13), and another discharge cell PC adjacent on the upper side (called “upper discharge cell”) is driven at the third gradation level (FIG. 13), the upper discharge cell PC is forcedly set to the lighting mode due to the write address discharge generated forcedly in the subfield SF3. Hence, the upper discharge cell is driven at the fourth gradation level although it is designed to be driven at the third gradation level. The luminance difference between the two discharge cells, i.e., the sustain discharge light emission in the subfield SF3, creates a gradation luminance error.

In order to deal with such error, the plasma display apparatus shown in FIG. 12 carries out the address operation shown in FIG. 9, FIG. 10 or FIG. 11 only in the selective write address stage Ww in the subfields SF1-SF3 among the subfields SF1-SF11 shown in FIG. 14 because the luminance weight of the subfields SF1-SF33 is smaller than a prescribed value. In other words, the address operation shown in FIG. 9, FIG. 10 or FIG. 11 is only performed in those subfields which are used for low luminance display because the image quality deterioration is indistinctive in the low luminance area.

In the above-described embodiment, the address operation is executed, as shown in FIG. 9, FIG. 10 or FIG. 11, in all of the subfields SF1-SF3. It should be noted, however, that such address operation may be executed in only one of the subfields SF1-SF3, or in only two of the subfields SF1-SF3. For example, if the driving in the twelve gradation levels (first-twelfth gradation levels) as shown in FIG. 13 is executed based on the pixel drive data GD, the address operation of FIG. 9, FIG. 10 or FIG. 11 may be executed only in the selective write address stage Ww of the subfield SF1 among the subfields SF1-SF3.

The driving scheme shown in FIG. 13 generates the write address discharge and sustain discharge, by a number corresponding to the luminance level (gradation level) to represent, in the subfields SF starting from the first subfield SF1 so that N+1 intermediate luminances (N+1 gradation levels) can be represented with N subfields SF. It should be noted, however, that the present invention is not limited to such driving method. For example, if N subfields SF are used, there are 2^{N} combinations of the subfields which can generate selective write address discharge and sustain discharge. If different luminance weights are allotted to the N subfields SF, it is possible to represent 2^{N} intermediate luminances corresponding to the 2 gradation levels. Out of such 2 combinations of the subfields, those combinations having high possibility of producing false (pseudo) contour may be eliminated, and the remaining combinations for intermediate luminances of 2^{K} gradation levels (K<N) may only be used.

For example, it should be assumed here that the subfields for each unit display period are the eleven subfields SF1-SF11, and the luminance weight for each subfield is as follows:

SF1: 1

SF2: 2

SF3: 4

SF4: 7

SF5: 11

SF6: 17

SF7: 24

SF8: 32

SF9: 41

SF10: 52

SF11: 64

Then, the combinations of the subfields which can generate the selective write address discharge is 2¹¹ (=2048) combinations in total. Out of these combinations, 2⁸ combinations are used. Specifically, 256 gradation levels are created with the 2⁸ subfield combinations. Other subfield combinations are removed because they would make reversal between the lighting state (with sustain discharge) state and the unlighting state (without sustain discharge) in those subfields which have relatively large luminance weight if gradation levels are next to each other (close to each other). In all the 256 (2⁸) combinations, the selective write discharge is generated in one of the subfields SF1, SF2 and SF3. Therefore, with such arrangement of the subfields, the address operation shown in FIG. 9, FIG. 10 or FIG. 11 may be applied to the subfield SF1, SF2, SF3.

With such driving, the write address discharge is forcedly generated in one of the subfields SF1-SF3, except for a case of black display (first gradation level). This ensures favorable driving with a satisfactory discharge probability in spite of an insufficient amount of electrically-charged particles. In the subfields after the subfield SF3, sustain discharge repeatedly generated in the sustain stages I of these subfields becomes a source of electrically-charged particles.

In order to reduce the above-described gradation luminance error, the following driving may be performed.

For example, the unit display period is divided into eleven subfields SF1-SF11, and the weights of the subfields SF1-SF11 are set as follows: SF1:1, SF2:2, SF3:4, SF4:7, SF5:11, SF6:17, SF7:24, SF8:32, SF9:41, SF10:52, SF11:64. Thus, the 256-gradation display can be provided.

It should be assumed here that one discharge cell A and another cell B adjacent on the upper side to the discharge cell A are caused to emit light at the gradation luminance levels 11 and 21, respectively. If the conventional driving method is used, the discharge cell A is set to the lighting mode only in the subfields SF3 and SF4, and the discharge cell B is set to the lighting mode only in the subfields SF1, SF2, SF4 and SF5. On the other hand, if the driving method shown in FIG. 9 is used, the discharge cell B is set to the lighting mode not only in the subfields SF1, SF2, SF4 and SF5, but also in the subfield SF3, so that the display gradation luminance level becomes 25. In this case, for example, a change is made so that the discharge cell B is brought into the lighting mode in only the subfields SF3, SF4 and SF5. As a result, the display gradation luminance level becomes 22, and the gradation error is reduced. Thus, by comparing the subfield lighting patterns of a certain discharge cell with the subfield lighting patterns of an adjacent discharge cell and then changing a combination of subfields to be set to the lighting mode in such a manner to reduce the gradation error, it is possible to repress the gradation error.

This application is based on Japanese Patent Application No. 2007-188525 filed on Jul. 19, 2007 and the entire disclosure thereof is incorporated herein by reference.

What is claimed is:

1. A method of driving a plasma display panel in a plurality of subfields for each unit display period of an input video signal, thereby to perform a gradation display, the plasma display panel having a plurality of row electrode pairs extending in a row direction of the plasma display panel, a plurality of column electrodes extending in a column direction of the plasma display panel and crisscrossing the row electrode pairs, and a plurality of discharge cells defined at intersections of said row electrode pairs and column electrodes, each said row electrode pair serving as each display line of the plasma display panel, and said discharge cells serving as pixels, the driving method comprising, in each said subfield:
an address stage of sequentially applying a scanning pulse to one row electrode in each said row electrode pair at a predetermined scanning period, and applying to said column electrodes, a pixel data pulse responsible for each pixel in accordance with said input video signal for every said scanning period, thereby inducing address discharge in said discharge cells so as to bring each of said discharge cells into a lighting mode or unlighting mode; and
a sustain stage of repeatedly inducing discharge in only those said discharge cells which are brought into said lighting mode, for a period corresponding to a luminance weight allotted to the subfield concerned, wherein in said address stage in at least one of said subfields of said unit display period, said scanning pulses are sequentially applied to a first row electrode to which one discharge cell belongs and to a second row electrode belonging to a display line adjacent to the first row electrode in the column direction in an overlapping manner for a predetermined period, so that said address discharge is generated in said one discharge cell and also in another discharge cell scanned immediately before said one discharge cell upon application of said pixel data pulse for said one discharge cell.

2. The plasma display panel driving method according to claim 1, wherein said subfields of said unit display period are allotted luminance weights respectively such that said luminance weight becomes greater in an ascending order from a first subfield to a last subfield, and said one subfield is allotted a luminance weight smaller than a predetermined luminance weight.

3. The plasma display panel driving method according to claim 2, wherein said one subfield is said first subfield.

4. The plasma display panel driving method according to claim 1, wherein said predetermined period is longer than a minimum discharge delay in said discharge cell.

5. The plasma display panel driving method according to claim 1, wherein a pulse width of said scanning pulse is approximately twice a pulse width of said pixel data pulse.

6. A method of driving a plasma display panel in a plurality of subfields for each unit display period of an input video signal, thereby to perform a gradation display, the plasma display panel having a plurality of row electrode pairs extending in a row direction of the plasma display panel, a plurality of column electrodes extending in a column direction of the plasma display panel and crisscrossing the row electrode pairs, and a plurality of discharge cells defined at intersections of said row electrode pairs and column electrodes, each said row electrode pair serving as each display line of the plasma display panel, and said discharge cells serving as pixels, the driving method comprising, in each said subfield:
an address stage of sequentially applying a scanning pulse to one row electrode in each said row electrode pair at a predetermined scanning period, and applying to said column electrodes, a pixel data pulse responsible for each pixel in accordance with said input video signal for every said scanning period, thereby inducing address discharge in said discharge cells so as to bring each of said discharge cells into a lighting mode or unlighting mode; and
a sustain stage of repeatedly inducing discharge in only those of said discharge cells which are brought into said lighting mode, for a period corresponding to a luminance weight allotted to the subfield concerned, wherein in said address stage in at least one of said subfields of said unit display period, said scanning pulses are sequentially applied to each of the row electrodes of first, second and third discharge cells adjacent to each other in the column direction in an overlapping manner for a predetermined period and a pulse width of said pixel data pulse is increased by an amount equivalent to said predetermined period, so that said address discharge is generated in the first, second and third discharge cells upon application of said pixel data pulse for said second discharge cell.

7. The plasma display panel driving method according to claim 6, wherein said subfields of said unit display period are allotted luminance weights respectively such that said luminance weight becomes greater in an ascending order from a first subfield to a last subfield, and said one subfield is allotted a luminance weight smaller than a predetermined luminance weight.

8. The plasma display panel driving method according to claim 7, wherein said one subfield is said first subfield.

9. The plasma display panel driving method according to claim 6, wherein said predetermined period is longer than a minimum discharge delay in said discharge cell.

5. The plasma display panel driving method according to claim 1, wherein a pulse width of said scanning pulse is approximately twice a pulse width of said pixel data pulse.

10. The plasma display panel driving method according to claim 6, wherein a pulse width of said scanning pulse is the same as a pulse width of said pixel data pulse.
